(19) United States
(12) Patent Application Publication
(10) Pub. No.: US 2025/0034392 A1
(43) Pub. Date: Jan. 30, 2025

(54) METHOD AND APPARATUS FOR PRODUCTION AND PROCESSING OF A MIXTURE OF RECYCLED POLYESTER MATERIAL AND A POLYESTER PREPOLYMER FROM A POLYESTER PRODUCTION PROCESS

(71) Applicant: POLYMETRIX AG, Oberbüren (CH)

(72) Inventors: Andreas CHRISTEL, Zuzwil (CH); Karl SCHÖPF, Obstalden (CH)

(73) Assignee: POLYMETRIX AG, Oberbüren (CH)

(21) Appl. No.: 18/709,302

(22) PCT Filed: Nov. 8, 2022
(86) PCT No.: PCT/EP2022/081115

§ 371 Date: May 10, 2024

(30) Foreign Application Priority Data
Nov. 12, 2021 (EP) 21207955.2
Dec. 6, 2021 (EP) 21212533.0
Sep. 27, 2022 (EP) 22198146.7

(51) Int. Cl. C08L 67/02; B01D 29/56; B01D 37/00; B01J 19/06; B01J 19/24; C08J 11/06

(52) U.S. Cl. CPC C08L 67/02; B01D 29/56; B01D 37/00; B01J 19/06; B01J 19/245; C08J 11/06; B01D 2201/165; B01D 2201/184; B01J 2219/00024; C08J 2367/02; C08L 2205/025; C08L 2207/20

(57) ABSTRACT

A process for producing a polyester solids mixture by adding together a proportion of recycled polyester material and a proportion of polyester material from a polyester manufacturing process. The proportion of recycled polyester material in the polyester solids mixture comprises 10-90% and has a b* value (BR), and the proportion of polyester material from a polyester manufacturing process in the polyester solids mixture comprises 90-10% and has a b* value (BN) and the resulting polyester solids mixture has a b* value (BM), wherein the BM<0, BN<0 and BR>BN.

This application is a National Stage completion of PCT/EP2022/081115 filed Nov. 8, 2022, which claims priority from European patent application 22198146.7 filed Sep. 27, 2022, European patent application 21212533.0 filed Dec. 6, 2021 and European patent application 21207955.2 filed Nov. 12, 2021.

### FILED OF THE INVENTION

For ecological reasons, the recycling of polyesters such as PET has become increasingly important. One variant involves mixing recycled polyester material with polyester prepolymer pellets from a polyester manufacturing process in order to obtain a high-quality product. Preferably, a recycled polyester is introduced into a polyester manufacturing process for this purpose.

### BACKGROUND OF THE INVENTION

WO 00/77071 A1 describes two options in which a recycled polyester can be introduced into a polyester production process.

In the first option, pre-cleaned recycled polyester material is extruded and pelletized to obtain recycled polyester pellets, which are subsequently mixed with polyester prepolymer pellets from a polyester manufacturing process and together are subjected to a solid phase polycondensation treatment.

In the second option, pre-cleaned recycled polyester material is extruded to obtain a recycled polyester melt, which is subsequently mixed with a polyester prepolymer melt from a polyester manufacturing process, pelletized together and subjected to a solid phase polycondensation treatment.

In both cases, the recycled polyester is cleaned in one or more of the following steps:
Removal of surface impurities in the solid phase, for example by means of a washing process;
Removal of impurities by thermal treatment in the solid phase, for example by a drying process;
Removal of impurities in the melting phase, for example by applying a vacuum or using a purge gas in a degassing chamber;
Removal of impurities by thermal treatment in the solid phase in a solid phase polycondensation step.

The removal of surface impurities reduces the content of volatile, semi-volatile and non-volatile impurities. However, this is limited to impurities that are present on the surface or are mixed with the recycled polyester. Impurities within the polyester, for example absorbed impurities or additives, are not affected.

A large proportion of volatile impurities can be removed during thermal treatment prior to extrusion. Nevertheless, only a small amount of the semi-volatile impurities are removed under the usually limited process conditions. The removal of semi-volatile impurities in this step could be increased by longer residence times and higher process temperatures. However, this would have detrimental consequences for the subsequent process steps and the quality of the recycled polyester (discoloration, formation of decomposition products, undesired increase in viscosity).

During extrusion, residual surface impurities, absorbed impurities and impurities present as separate particles are homogeneously mixed with the recycled polyester melt. At the same time, regenerated impurities are produced. These regenerated impurities include degradation products of impurities as well as degradation products of the recycled polyester, wherein the degradation of the polyester is often accelerated (catalyzed) by the impurities present.

WO 00/77071 A1 describes the possibility of using a degassing chamber. However, extensive use of such devices to remove large quantities of semi-volatile impurities would have very detrimental consequences for the quality of the recycled polyester (discoloration, formation of decomposition products). Apart from this, the problem of the formation of degradation products would not be solved.

It is clear from the above that impurities from recycled polyester are introduced into the solid-phase polycondensation step at the end of the process chain. Nevertheless, WO 00/77071 A1 only refers to standard technology for carrying out solid-phase polycondensation. However, processing a mixture of newly produced polyester (so-called “virgin” material) with recycled polyester cannot be processed continuously over a required longer operating time in a conventional solid-phase polycondensation plant due to the significantly higher contamination with impurities.

EP-3 865 529 A1 describes a possibility of removing volatile and partially volatile impurities that enter the gas phase and can be removed by cleaning the process gas.

However, further disadvantages result from impurities that remain in the melt. These include solid impurities and coloring, yellowing impurities, which are essentially carried in with the recycled polyester material or are formed from the recycled polyester material. Despite the surface cleaning of the recycled polyester material carried out in the prior art in a washing process, residues of impurities can adhere to the surface. In addition, residues of washing chemicals used in the washing process can adhere to the surface. Such impurities usually have a lower thermal stability than the polyester material and, at the temperatures in a polyester melt, lead to coloring degradation products that cause the recycled polyester material to yellow.

At the same time, the recycled polyester material may contain less thermally stable additives, or foreign plastics may be introduced into the polyester melt, which also lead to yellowing.

The solid impurities described above cannot be satisfactorily removed using the procedure proposed in EP-3 865 529 A1. The above-mentioned problem of yellowing of the material is also not solved in this prior art.

### SUMMARY OF THE INVENTION

It was the problem of the present invention to overcome the disadvantages of the prior art discussed herein and to provide an improved process and apparatus for producing and processing a mixture of recycled polyester material and a polyester prepolymer from a polyester manufacturing process.

According to the invention, the present problem is solved by a process according to the independent claim(s).

More specifically, the present invention relates to a process for producing and processing a mixture of recycled polyester material and a polyester prepolymer from a polyester manufacturing process, comprising the following steps:
Provision of a recycled polyester material in the form of a melt and first purification of the melt by removing solid impurities using melt filtration;
Mixing of the recycled polyester material in the form of a melt with a polyester prepolymer in the form of a melt from a polyester manufacturing process and subsequent production of a solid mixture, preferably in a first particle forming device;
Treatment of this solid mixture in a reactor for the thermal treatment of bulk materials with a process gas in counterflow or crossflow to the flow direction of the mixture;
   characterized in that, at least for a first period after the start of the process, at least one additional step for purifying the melt by removing solid impurities to obtain a purer recycled polyester material is carried out before the solid mixture is produced.

This process is characterized in particular by the fact that substances introduced into the process by the recycled polyester material can be reliably removed before thermal treatment, for example solid phase condensation. This enables reliable and continuous processing of a mixture of recycled polyester material and a polyester prepolymer from a polyester manufacturing process.

Bulk materials are any form of free-flowing, solid particles, such as grains, flakes, pellets, powders or agglomerates.

According to the invention, the bulk materials are polycondensates, namely polyester in the form of a solid.

Polyesters are obtained from their monomers by polycondensation. Polymers of one polymer type can be obtained from the same main monomers. Polymers of one polymer type can also be obtained from several main monomers. The individual monomers can be arranged alternately, randomly or in blocks. A limited quantity of further monomers, so-called comonomers, can also be used.

Monomers can be obtained from fossil fuels, such as crude oil, natural gas or coal, or from renewable raw materials. Monomers can also be obtained by depolymerization or pyrolysis from existing polymers, in particular recycled polymers.

Polycondensates are obtained by a polycondensation reaction with the elimination of a low-molecular reaction product. The polycondensation can take place directly between the monomers. The polycondensation can also take place via an intermediate product, which is then converted by transesterification, wherein the transesterification can again take place with elimination of a low-molecular reaction product or by ring-opening polymerization. The polycondensate obtained in this way is essentially linear, although a small number of branches may occur.

Suitable polymers according to the invention are polyesters including polyhydroxyalkanoates, polylactides or copolymers thereof.

Polyesters are polymers which are usually obtained by polycondensation from a diol component with the general structure HO—R¹—OH and a dicarboxylic acid component with the general structure HOOC—R²—COOH, where R¹ and R² are usually aliphatic hydrocarbons with 1 to 15 carbon atoms, aromatic hydrocarbons with 1 to 3 aromatic rings, cyclic hydrocarbons with 4 to 10 carbon atoms or heterocyclic hydrocarbons with 1 to 3 oxygen atoms and 3 to 10 carbon atoms.

Linear or cyclic diol components and aromatic or heterocyclic dicarboxylic acid components are usually used. Instead of the dicarboxylic acid, its corresponding diester, usually dimethyl ester, can also be used. Furthermore, the reaction product of a dicarboxylic acid with two diols, which is present in particular in the form of the structure HO—R¹—OOC—R²—COO—R¹—OH, can be used partially or completely instead of the dicarboxylic acid. An example of this is the use of bis(2-hydroxyethyl) terephthalate for the production of polyethylene terephthalate.

Typical examples of polyesters are polyethylene terephthalate (PET), polybutylene terephthalate (PBT), polytrimethylene terephthalate (PTT), polyethylene furanoate (PEF), polytrimethylene furanoate (PTF), polybutylene succinate (PBS) and polyethylene naphthalate (PEN), which are used either as homopolymers or as copolymers.

Polyesters are also polymers with repeating ester groups with the general structure H—[O—R—CO]ₓ—OH, where R is usually an aliphatic hydrocarbon with 1 to 15 carbon atoms, an aromatic hydrocarbon with 1 to 3 aromatic rings, a cyclic hydrocarbon with 4 to 10 carbon atoms or a heterocyclic hydrocarbon with 1 to 3 oxygen or nitrogen atoms and 3 to 10 carbon atoms.

One example are polyhydroxyalkanoates with the general structure H—[O—C(R)H—(CH₂)ₙ—CO]ₓ—OH, where R is usually a hydrogen or an aliphatic hydrocarbon with 1 to 15 carbon atoms and n is 1 to 10. Examples are poly-4-hydroxybutyrate and poly-3-hydroxyvalerate.

Another example are polylactides with the general structure H—[O—C(R)H—CO]ₓ—OH, where R is usually a methyl group or an aliphatic hydrocarbon with 1 to 15 carbon atoms.

Another example is polyglycolic acid with the general structure H—[O—CH₂—CO]ₓ—OH.

Polyesters are also polymers which are produced by ring-opening polymerization from heterocyclic monomers with an ester group, such as polycaprolactone from caprolactone, or by ring-opening polymerization from heterocyclic monomers with at least two ester groups, such as polylactide from lactide.

The most common polylactide is polylactic acid with the structure H—[O—C(CH₃)H—CO]ₓ—OH. Due to the chirality of lactic acid, various forms of polylactic acid exist. Homopolymers are poly-L-lactide (PLLA), which is usually produced from L,L-lactide, and poly-D-lactide (PDLA), which is usually produced from D,D-lactide. Copolymers such as poly-(L-lactide-co-D,L-lactide) contain small amounts of lactide units with a chirality that differs from the main monomer.

Polyesters can also be produced by biosynthesis with the help of microorganisms or in plant cells, from which they are obtained by breaking down the cell.

The suitable polyesters may be homopolymers. Despite the term homopolymer, a small proportion of comonomers can form during the manufacturing process. For example, the formation of diethylene glycol from ethylene glycol is known to occur in the production of polyethylene terephthalate. However, many suitable polyesters are copolymers that contain a certain proportion of comonomers. The comonomers may be introduced as part of the monomers in the manufacturing process of the polyester, or they may form as part of the manufacturing process, usually resulting in a random distribution in the final polyester. The comonomers can also be introduced as blocks made from different monomers, resulting in so-called block copolymers.

The suitable polyesters can be polymer mixtures, which can contain any number and quantity of different types of polyester. A small amount of one polyester can act as a nucleating agent in other polyesters, thereby increasing their crystallization rate.

Specific polyester mixtures can form interacting crystal structures with a crystallization behaviour that differs from the individual components. An example of this is a mixture of PDLA and PLLA, which forms a stereocomplex crystal structure with increased crystallinity.

After polymerization, each polymer chain has chain-terminating groups usually with the functionality of at least one of its monomers. As an example, a polyester chain may have one or more hydroxyl and/or carboxyl end groups. Such end groups may be modified by a so-called end-capping reagent or by a degradation reaction. Although not specifically mentioned in the above general structures, suitable polyesters may have such modified end groups.

Additives can be added to the polyester. Suitable additives include catalysts, colorants and pigments, UV blockers, processing aids, stabilizers, impact modifiers, blowing agents of a chemical and physical nature, fillers, nucleating agents, flame retardants, plasticizers, particles that improve barrier or mechanical properties, reinforcing bodies such as spheres or fibers, and reactive substances such as oxygen absorbers, acetaldehyde absorbers or substances that increase molecular weight.

The polyester can be a virgin material or a recyclate. A virgin polyester material is a polyester that is made from its monomers, where the monomers can be derived from petroleum-based sources, from biologically renewable raw materials or from the depolymerization of polyester articles or waste, where monomers can also include dimers and lower oligomers with a chain length of up to 9 repeating units of the polyester. The polyester is not considered virgin material if it falls under the definition of a recyclate.

Recycled polyesters from the manufacturing and processing operations (post-industrial) or polyesters collected and recycled after consumer use (post-consumer) are referred to as recyclates. A polyester recyclate to be used according to the invention preferably still has a chain length of at least 10 (preferably 20, in particular 30 or 40) repeating units of the polyester. Recycled polyesters can preferably consist of consumer waste, for example used polyester articles. Typical examples of such articles are polyester bottles, polyester trays or polyester fibers. Depending on their size and composition, the polyester articles must be ground and/or compacted in order to obtain suitable particle sizes and bulk weights for further processing. Suitable bulk weights are between 100 and 800 kg/m³, in particular between 200 and 500 kg/m³. Suitable particle sizes are between 1 and 50 mm, in particular between 2 and 25 mm. Depending on their degree of contamination, recycled polyesters must be cleaned before further processing. This can include process steps such as washing, sorting or separating. Furthermore, recycled polyesters can be separated from volatile impurities and water by means of thermal treatment in a gas stream and/or at reduced pressure.

The present invention is directed to the processing of a mixture of recycled polyester material and a polyester prepolymer from a polyester manufacturing process.

According to the invention, polyester prepolymer is provided from a polyester manufacturing process in the form of a melt in a first reactor or a series of reactors, the reactor in which the polyester prepolymer ultimately used as the starting material of the process according to the invention is produced being referred to as the first reactor. Polyester production processes and suitable reactors for this purpose are sufficiently known in the prior art (e.g. Scheirs/Long (eds.), Modern Polyesters, Wiley 2003, II.2.4, pp. 89-98).

Continuous polyester production processes are preferred for the present invention. According to the present invention, suitable polyester manufacturing processes are designed such that a polyester prepolymer melt is produced by means of melt phase polymerization. The melt-phase polymerization comprises a process step in which the suitable viscosity for further processing is achieved. This can take place in a melt phase reactor, for example. Once the suitable viscosity has been achieved, the polyester melt is fed through suitable melt lines to one or more pelletizers.

Optionally, the polyester prepolymer melt can be filtered in a melt filter. The term melt filter includes screen changers and static filters or filter cartridges.

According to the invention, the recycled polyester material is provided in the form of a melt in a second reactor, preferably an extruder.

A melt of recycled polyesters is usually produced by extrusion. Alternatively, however, simple melting reactors can also be used. The recycled polyester melt can optionally be subjected to further pressure build-up by means of a melt pump and/or separation of volatile impurities by means of entrained gas or vacuum.

According to a preferred embodiment of the present invention, the melt of recycled polyesters is subjected to a separation of solid impurities by means of melt filtration before it is mixed with a polyester prepolymer in the form of a melt from a polyester manufacturing process. The first filter unit used for this is located downstream of the second reactor. In other words, the melt of recycled polyesters from the second reactor is fed into the first filter unit through a feed line (melt line).

Preferably, the recycled polyester melt is filtered through a first filter unit, for example a sieve, with openings comparable to or smaller than the openings in the filter unit, for example a sieve, for filtering the melt in the polyester production process.

The filter units used according to the invention have a large number of openings through which the melt can pass while the solids are retained. The openings can be round, angular or irregularly shaped. Round openings are mainly found in lock plates. Here, the hole diameter indicates the size of the opening. Angular or irregularly shaped openings are mainly found in woven screens. In simple woven screens, the mesh size indicates the size of the opening. In screen fabrics with a complex structure, such as dutch weaves, a nominal opening size results from the size of the retained particles.

Melt filters are usually operated with several sieves with openings of different sizes, so-called sieve packs. The openings in the finest sieve are decisive. Particularly with screens, but also with lock plates, displacement, expansion or wear can occur, resulting in slightly different aperture sizes. For this reason, the average opening size is determined as an average value over the entirety of the openings.

The recycled melt is fed from the first filter unit through a melt line to a first melt valve serving as a connection unit, where it is combined and mixed with a melt of polyester prepolymer from a polyester manufacturing process. The melt line can, for example, be a corresponding pipeline connecting piece.

The melt mixture is then fed in a common melt line into a unit for producing a solids mixture, preferably in a first particle forming device, particularly preferably a pelletizer (for example an underwater pelletization unit (UWG) or an underwater strand pelletization unit (USG)), where it is pelletized.

The first particle forming device can also be a plurality of particle forming devices that are operated in parallel.

According to a preferred embodiment of the present invention, the melt mixture can be mixed in a mixing unit before entering the unit to produce a solid mixture. Any mixing unit suitable for mixing melts can be used for this purpose. For example, a mixing unit with a static mixer can be used.

According to the invention, a mixture of solids is understood to be a mixture of particles, in particular pellets, of different compositions, wherein a mixture of virgin PET particles and rPET particles may be present. However, it can also be particles or pellets which have been produced by mixing a recycled melt and a melt of polyester prepolymer from a polyester manufacturing process and subsequent particle shaping, in particular pelletization, of this mixed melt.

The first melt valve is located between the process step in which the suitable viscosity of the melt for further processing is achieved (e.g. in a melt polycondensation unit or an extruder) and a unit for producing a solid mixture, preferably a pelletizer. The first melt valve can be located before or after an optional filtration in the polyester manufacturing process.

According to the invention, the feed line (melt line) for recycled polyester melt can preferably be shut off by the first melt valve.

According to the invention, a second melt valve is preferably arranged in the feed line (melt line) for recycled polyester melt upstream of the first melt valve, which also allows the feed line (melt line) for recycled polyester melt to be shut off. In this case, the second melt valve is connected to the first filter unit via a first section of the melt line and to the first melt valve via a second section of the melt line.

For continuous operation of the plant, it is necessary to carry out an additional cleaning step. Continuous operation of the plant is understood here to mean operation of the plant over a longer period of time (for example 1-4 weeks, preferably 1-12 months, particularly preferably more than 1 year) without interruption, in which the melts are passed through the melting area of the plant without intermediate interruptions.

During the start-up and continuous operation of the plant, the recycled polyester material introduces impurities into the plant that have a negative impact on the quality of the final product. These product impurities are also referred to as black specs.

In order to reliably remove these impurities during continuous operation, the melt must be subjected to an additional purification step before the solid mixture is produced in order to remove the solid impurities responsible for the formation of black specs while obtaining a purer recycled polyester material.

According to a preferred embodiment of the present invention, the additional step of purifying the melt of the recycled polyester material by means of melt filtration takes place in an additional second filter unit. In principle, all types of filter units can be used. These include discontinuously operated filters, such as cartridge filters. Continuously operated filter units, in which an uninterrupted melt flow is ensured, are preferred. This includes continuously cleaning filter units (such as laser filters) and discontinuously cleaning filter units (such as piston filters), wherein discontinuous filter units pose the risk of surge contamination.

Preferred filters according to the invention are selected from the following group:
A rigid perforated plate or a rigid screen with continuous cleaning from the melt flow
A rigid perforated plate or a rigid screen with pulsed cleaning from the melt flow
A movable perforated plate or a movable screen with continuous feed into the melt flow
A movable die plate or a movable screen with pulsed feed into the melt flow, where the pulse rate is less than 5 minutes.

Such filters are well known (e.g. Scheirs, Polymer recycling, Wiley 1^{st} ed. 1998, 101-117).

According to the invention, the second melt filter preferably has openings with an average size which is larger than the average size of the openings of the first melt filter used during the first cleaning. The use of a coarser second melt filter avoids the need for frequent cleaning with necessary interruption of plant operation, since such a second melt filter is significantly less prone to clogging.

According to a preferred embodiment of the present invention, the first filter unit can have openings with a size in the range of 10-75 μm, preferably 30-60 μm, and more preferably 35-45 μm, while the second filter unit can have openings with a size in the range of 10-300 μm, preferably 20-100 μm, preferably 40-75 μm, and more preferably 50-60 μm. In this case, the openings of the second filter unit must always be coarser than the openings of the first filter unit.

In the case of a further embodiment of the present invention, in which filtration of the polyester prepolymer melt is carried out in a melt filter, this filtration takes place in a third filter unit before the polyester prepolymer melt enters the first melt valve. In this embodiment, the third filter unit preferably has openings with a size in the range of 10-75 μm, preferably 30-60 μm, and more preferably 35-45 μm, and particularly preferably corresponds to the size of the openings of the first filter unit.

According to the invention, the additional step of purifying the melt of the recycled polyester material by means of melt filtration in an additional second filter unit must take place before the production of the solid mixture, i.e. before the melt mixture is introduced into the unit for producing a solid mixture, preferably a pelletizer.

According to a preferred embodiment of the present invention, the additional step of purifying the melt of the recycled polyester material by melt filtration is carried out prior to the step of mixing the recycled polyester material in the form of a melt with the polyester prepolymer in the form of a melt from a polyester manufacturing process. For this purpose, a melt filter as described above is provided as a second filter unit at a position which is located downstream of the first filter unit and upstream of the first melt valve. In other words, a second filter unit is arranged in the melt line connecting the first filter unit to the first melt valve. In this way, the melt of the recycled polyester material is additionally purified before it comes into contact with the polyester prepolymer melt.

Optionally, a second melt valve described above can be arranged between the first filter unit and the second filter unit.

Also optionally, a second melt valve described above can be arranged upstream of the first filter unit and downstream of the second reactor.

In both cases, it is possible for polyester prepolymer melt from a polyester manufacturing process to flow in the opposite direction through a filter unit. The melt filter must be selected accordingly. It may be necessary to temporarily remove screens or perforated plates from the filter unit.

According to a further preferred embodiment of the present invention, the additional step of purifying the melt of the recycled polyester material by melt filtration is carried out after the step of mixing the recycled polyester material in the form of a melt with the polyester prepolymer in the form of a melt from a polyester manufacturing process.

For this purpose, a melt filter as described above is provided as a second filter unit at a position which is located between the first melt valve and the unit for producing a solid mixture. In other words, a second filter unit is arranged in the melt line connecting the first melt valve to the unit for producing a solid mixture. In this way, the entire melt mixture prepared in advance is additionally purified.

Optionally, in this embodiment, a second melt valve described above can be arranged between the first filter unit and the first melt valve.

According to a further embodiment of the present invention, an additional step of purifying the melt by removing solid impurities to obtain a purer recycled polyester material can be performed by purging the melt line connecting the first filter unit and the first melt valve. Through this melt line, recycled polyester material in the form of a melt is fed to the production of the solid mixture during normal operation by directing this melt from the first filter unit to the first melt valve.

In order to remove solid impurities that are deposited in this melt line before or during plant operation, a section of this melt line that connects the first melt valve and the second melt valve can be flushed using the polyester prepolymer melt. For this purpose, polyester prepolymer melt is fed from the first reactor through the first melt valve into this melt line. The polyester prepolymer melt is then fed through the second melt valve into a second particle forming device. There, a solid is produced from this melt, with the deposited impurities carried along being discharged.

The second particle forming device, in particular preferably a pelletizer, can be of the same design as the first unit described above for producing a solid. However, this is not mandatory.

The second particle forming device is connected to the second melt valve.

According to this embodiment, the first melt valve and the second melt valve are designed to be switchable, so that
in a first switching arrangement, polyester prepolymer in the form of a melt from a polyester manufacturing process is passed through the first melt valve and the second melt valve into the second particle forming device, entraining deposited impurities from at least the section of the melt line between the first melt valve and the second melt valve,
in a second switching arrangement, polyester prepolymer in the form of a melt from a polyester manufacturing process is passed through the first melt valve to the unit for producing a solid mixture and melt of recycled polyester material from the first filter unit is passed through the second melt valve and the first melt valve to the unit for producing a solid mixture, and
if necessary, in a third switching arrangement, polyester prepolymer in the form of a melt from a polyester manufacturing process is fed through the first melt valve to the unit for producing a solid mixture and melt of recycled polyester material from the first filter unit is fed through the second melt valve into the second particle forming device.

Such switchable melt valves are known (see e.g. EP 0 962 299 A1).

In the first switching arrangement, the first melt valve is set in such a way that polyester prepolymer melt coming from the first reactor is no longer directed exclusively to the (first) unit for producing a solid, but at least partially into the section of the melt line connecting the second melt valve and the first melt valve. During normal operation, recycled polyester melt is fed through this melt line in the reverse direction of flow in order to reach the first melt valve and then the (first) unit for producing a solid. Here, the recycled polyester melt picks up impurities deposited in this melt line and introduces them into the final product. This is prevented by the purging process according to the invention. The polyester prepolymer melt passed through this section of the melt line picks up impurities deposited in this melt line as it passes through.

The polyester prepolymer melt contaminated in this way is not used for product manufacture, but is fed to a second particle forming device.

In the first switching arrangement, the second melt valve is therefore set in such a way that contaminated polyester prepolymer melt coming from the first reactor through the section of the melt line between the first and second melt valves is not directed to the second reactor, but to the second particle forming device.

This second particle forming device is connected to the second melt valve. The connection is preferably realized by another melt line.

In the second particle forming device, the contaminated polyester prepolymer melt is solidified, preferably pelletized. The resulting solid material is removed from the plant. Optionally, the solid material obtained in this way can be returned at a later stage as recycled polyester.

The second switching arrangement of the first and second melt valves represents the switching state in normal operation. Melt of recycled polyester material is fed from the first reactor through the first filter unit into the second melt valve and from there through the (now cleaned) section of the melt line into the first melt valve. In the second switching arrangement, the second melt valve is therefore set in such a way that melt of recycled polyester material cannot enter the second particle forming device. In the second switching arrangement, the first melt valve is set accordingly in such a way that melt of recycled polyester material is directed into the (first) unit for producing a solid. An inflow of polyester prepolymer melt into the section of the melt line between the first and second melt valves is prevented by directing the melt of recycled polyester material into the first melt valve at a sufficiently high pressure.

The third switching arrangement of the first and second melt valves represents the switching state in an additional optional cleaning step. This additional optional cleaning step is used to remove solid impurities that may be deposited in the section of the melt line between the first filter unit and the second melt valve. Melt of recycled polyester material is fed from the second reactor through the first filter unit into the second melt valve and from there into the second particle forming device. In the third switching arrangement, the second melt valve is therefore set in such a way that melt of recycled polyester material cannot enter the first melt valve. In the third switching arrangement, the first melt valve is preferably set accordingly in such a way that polyester prepolymer melt cannot enter the second melt valve, but is guided through the first melt valve to the unit for producing a solid mixture.

In the third switching arrangement, molten recycled polyester that does not meet the desired specifications can also be discharged from the plant. This may be start-up material, which in particular has too low a viscosity and too strong a yellow coloration, or a material that is outside the desired specifications for critical quality parameters (such as viscosity or color) due to impurities. This material is fed analogously to the further unit for producing a solid, preferably to the second particle forming device, where it is solidified as described above and optionally returned to the second reactor.

A fourth optional switching arrangement of the first and second melt valves represents the switching state for switching from the first to the second switching state. The melt valves are set in such a way that both polyester prepolymer melt from the first reactor (through the first melt valve) and recycled polyester material melt from the second reactor (through the first filter unit) are fed into the second particle forming device via the second melt valve. The melt flow through the section of the melt line between the first melt valve and the second melt valve is determined by the pressure at which the different melts are fed through the plant. In this arrangement, the pressure of the polyester prepolymer melt is greater than the pressure of the melt of recycled polyester material.

A further embodiment of the present invention provides that the second particle forming device is a device for underwater pelletization and the second melt valve is simultaneously the start-up valve of the underwater pelletization.

According to an alternative embodiment of the present invention, purging of the melt line can also be carried out exclusively with the melt of the recycled polyester material. For this purpose, it is advantageous to arrange the second melt valve as close as possible to the first melt valve. In a preferred embodiment, the second melt valve is integrated directly into the first melt valve. The section of the melt line connecting the first melt valve to the second melt valve is thus kept as short as possible, so that purging of this section is no longer necessary.

According to this alternative embodiment, the first melt valve and the second melt valve are designed to be switchable, so that
the first switching arrangement provided in the embodiment described above is no longer preferred and is preferably omitted,
in a second switching arrangement, polyester prepolymer in the form of a melt from a polyester manufacturing process is passed through the first melt valve to the unit for producing a solid mixture and melt of recycled polyester material from the first filter unit is passed through the second melt valve and the first melt valve to the unit for producing a solid mixture,
in a third switching arrangement, polyester prepolymer in the form of a melt from a polyester manufacturing process is passed through the first melt valve to the unit for producing a solid mixture and melt of recycled polyester material from the first filter unit is passed through the second melt valve into the second particle forming device, and
in a fourth switching arrangement, polyester prepolymer in the form of a melt from a polyester manufacturing process is passed through the first melt valve to the unit for producing a solid mixture and melt of recycled polyester material from the first filter unit is passed through the second melt valve into the second particle forming device and simultaneously through the second melt valve and the first melt valve to the unit for producing a solids mixture.

The components used in the two alternative embodiments with the same names are basically the same.

In this alternative embodiment, in the third switching arrangement, the section of the melt line between the first filter unit and the second melt valve is purged exclusively with the melt of the recycled polyester material. A first switching arrangement, in which a section of the melt line between the first melt valve and the second melt valve would be purged with polyester prepolymer in the form of a melt from a polyester manufacturing process, is preferably not set in this alternative embodiment.

In order to minimize the problem of any build-up of impurities in the section of the melt line that connects the first melt valve to the second melt valve, this section is kept as short as possible in this alternative embodiment. According to a preferred embodiment, a first melt valve is provided in which the second melt valve is integrated. Such melt valves are known. For example, such a first melt valve can be designed in such a way that the melt lines coming from the first reactor and second reactor (possibly with filter units arranged therein) flow into the first melt valve and are brought together there in the actual first melt valve. A branch line leading to a drain valve is arranged in the immediate vicinity upstream of this point where the melt lines merge. This drain valve represents the second melt valve and regulates the flow of the melt of recycled polyester material into the second particle forming device.

In the second switching arrangement described above, the second melt valve is therefore set in such a way that melt of recycled polyester material cannot enter the second particle forming device. In the second switching arrangement, the first melt valve is set accordingly in such a way that both polyester prepolymer in the form of a melt from a polyester manufacturing process and melt of recycled polyester material enter the first melt valve, where they are combined and fed to the unit for producing a solid mixture. This is the operating mode of the plant for producing the desired solid mixture. An inflow of polyester prepolymer melt into the section of the melt line between the first and second melt valves is prevented by directing the melt of recycled polyester material into the first melt valve at a sufficiently high pressure.

In the third switching arrangement described above, on the other hand, the second melt valve is therefore set in such a way that melt of recycled polyester material cannot enter the first melt valve. In the third switching arrangement, the first melt valve is preferably set accordingly in such a way that polyester prepolymer melt cannot enter the second melt valve, but is fed through the first melt valve to the unit for producing a solid mixture. In this switching arrangement, the melt of recycled polyester material is fed through the second melt valve into the second particle forming device. There, entrained deposits from the melt line coming from the second reactor are solidified together with the melt of recycled polyester material and optionally fed back into the second reactor. The polyester prepolymer in the form of a melt from a polyester manufacturing process is fed through the first melt valve to the unit for producing a solid mixture.

In the fourth switching arrangement described above, in contrast to the third switching arrangement, the first melt valve is set in such a way that it is not blocked for the inflow of melt of recycled polyester material. A portion of the melt of recycled polyester material thus passes into the first melt valve and then into the unit for producing a solid mixture, while another portion of the melt of recycled polyester material is fed through the second melt valve into the second particle forming device. The ratio of the amounts of melt of recycled polyester material passing through the two different conduit paths can be controlled by adjusting the first melt valve and the second melt valve accordingly. In this switching arrangement, which represents a transitional state of operation of the plant, a partial removal of deposits in the corresponding melt line from the plant is thus realized while the desired solid mixture is being produced. The melt flow through the section of the melt line between the first melt valve and the second melt valve is determined by the pressure at which the various melts are fed through the plant. In this arrangement, the pressure of the polyester prepolymer melt is lower than the pressure of the melt of recycled polyester material.

In the embodiments according to the invention with an additional step for cleaning the melt of the recycled polyester material by purging a section of the melt line either between the second and first melt valve or between the first filter unit and the second melt valve, a further step for cleaning the melt of the recycled polyester material by means of melt filtration can preferably also be carried out.

As described above, a second filter unit with a melt filter whose openings have an average size that is larger than the average size of the openings of the melt filter used in the first cleaning process is used for this purpose. Reference is made to the above description of the second filter unit.

In these embodiments according to the invention, the further step of purification by melt filtration is carried out after the step of mixing the recycled polyester material in the form of a melt with the polyester prepolymer in the form of a melt from a polyester manufacturing process. In other words, the second filter unit is provided at a position located between the first melt valve and the unit for producing a solid mixture.

A further disadvantage of the process according to WO 00/77071 A1 is the frequently varying quality of the recycled input material. Excessive quantities of impurities, some of which are present in clusters, can often not be detected by analytical measures. Quality defects are usually only apparent after pelletization or sometimes only in the end product. This can result in large quantities of inferior production batches in which not only the recycled polyester but also the polyester prepolymer from the manufacturing process becomes unusable.

According to a further preferred embodiment of the invention, a quality parameter is therefore measured in the melt line for recycled polyester melt.

The measured quality parameter can be used to automatically discharge the recycled polyester melt from the plant when a critical value is reached, as described above for the third switching arrangement.

Alternatively, the measured quality parameter can be used to make settings in the polyester manufacturing process based on the measured parameter or to make automatic adjustments to process parameters by means of a control system. The measurement of a color value and the adjustment or control of a colorant addition in the polyester production process is particularly preferred.

Alternatively, the measuring point can also be located after the first melt valve.

Quality parameters include in particular color and viscosity. Both can be measured in-line or on-line. Viscosity is measured in-line, for example, using measuring devices that measure the torsional force of a measuring probe in the melt. Viscosity is also measured in-line, for example, by measuring the pressure drop in a defined measuring gap through which the melt flows, wherein the measured melt remains in the process or is fed back into it. An on-line measurement of the viscosity is carried out, for example, by measuring the pressure drop in a defined measuring gap through which part of the melt flows, wherein the measured melt is removed from the process. In all cases, a viscosity is calculated by measuring a mechanical variable on the basis of comparative measurements.

An in-line measurement of the color is carried out, for example, using a light source on one side of the melt line and a light-sensitive sensor on the other side of the melt line, wherein a color value can be calculated using the amount of light absorbed at different wavelengths.

An on-line measurement of the color is carried out, for example, by means of a light source on one side of a test strip made from the melt and a light-sensitive sensor on the other side, wherein a color value can be calculated using the amount of light absorbed at different wavelengths. The light source and sensor can be connected to the actual measuring point via optical guiding means.

Optionally, melt pumps can be used in melt lines to overcome a pressure loss in the melt lines, the melt filters and the particle forming devices. Melt pumps usually have a predetermined flow direction and must be arranged in such a way that no melt flow occurs in the opposite direction. Preferred installation locations are after the first reactor or after the second melt filter, after the second reactor or after the first melt filter or after the third melt filter, wherein the arrangement in the melt line between the first and second melt valves should be avoided if, according to the invention, a flow through this section of the melt line is carried out in the reverse direction.

Throttle valves can also be used as an option to adjust or regulate the pressure ratios according to the required flow direction and quantity.

According to a preferred embodiment of the present invention, the solid phase polycondensation step is dimensioned such that both the substantially full capacity of the polyester prepolymer production process and the substantially full amount of the installed capacity of recyclate can be processed. Particularly in the event of a subsequent retrofitting of a polyester production plant, the total plant capacity can be increased after the installation of a recyclate feed unit by expanding the solid phase polycondensation.

The mixture of recycled polyester and polyester prepolymer from a polyester manufacturing process can comprise any desired mixing ratio. According to the invention, the ratio of recyclate to prepolymer is preferably in the range from 10% to 90% to 90% to 10%, more preferably from 20% to 80% to 80% to 20%, even more preferably from 25% to 75% to 75% to 25%, and particularly preferably 50% to 50%.

A limiting factor here is that a plant for the production of polyester prepolymer is designed with a certain size and its output cannot be reduced arbitrarily. A preferred embodiment of the present invention therefore provides for a mixture of recycled polyester and polyester prepolymer from a polyester manufacturing process with a maximum content of 50% recyclate. The minimum recycled content of the mixture results from the economy of the additional process step of mixing, which usually requires a recycled content of at least 10%, in particular at least 15%.

An additional problem may be that the recycled polyester has an insufficient blue coloration due to its previous history, which is commercially desirable for the product to be manufactured according to the invention.

The color of a material is characterized by the b* value. It is known that in the CIELAB color space, the b* value defines where the b* axis runs between the colors blue and yellow (see Römpp Lexikon Lacke und Druckfarben, Thieme 1998, “CIE”). A positive b*− value corresponds to a yellow coloration, and a negative b*− value corresponds to a blue coloration. According to the invention, the b* values are preferably measured by means of a colorimeter, for example Konica-Minolta CM3500d, using a D65 lamp in reflection mode. To measure the comparative b* values, all samples must be in the same state; e.g. same particle type (pellets, powder or formed bodies), same shape (round or cylindrical pellets or thickness of formed bodies), and same crystallinity state (amorphous or crystalline). To measure absolute values, all samples are preferably converted into pellets with a weight of 10-30 mg per pellet and crystallized (20 min/175° C. or comparable conditions) to obtain crystalline pellets. To assess whether a formed body has a b* value <0, a measurement can also be carried out directly on the formed body. For better measurability, the formed body can be ground, preferably using a sieve with an opening in the range of 0.5-1 mm. Grinding must be carried out under cooling to prevent discoloration due to grinding.

According to the invention, it has been shown that the desired blue coloration of the product to be manufactured, as described above, can be achieved by adding a coloring additive with a negative b* value to the process chain for producing the polyester prepolymer.

The process chain for producing the polyester prepolymer comprises the steps of producing a monomer mixture, esterifying the monomers, prepolymerization and melt-phase polymerization in a finisher. The coloring additive must be added before completion of the melt phase polymerization. The additive can be added in one of the aforementioned process steps of the process chain or in a line connecting the process steps.

According to a preferred embodiment according to the invention, the proportion of recycled polyester material in the solid mixture comprises 10-90% and has a b* value (BR), and the proportion of polyester prepolymer from a polyester manufacturing process in the solid mixture comprises 90-10% and has a b* value (BN), and wherein the resulting solid mixture has a b* value (BM) and BM<0, BN<0 and BR>BN.

According to the invention, it is preferred that BN is <−3, preferably <−5, and even more preferably <−8.

It is further preferred according to the invention that the proportion of recycled polyester material comprises >20%, preferably >25% and particularly preferably >40%, relative to the total polyester solid mixture.

In one embodiment according to the invention, the desired slightly negative BM value can be achieved by compensating for yellowing of the recycled polyester material (i.e. BR is above 0) by mixing it with a sufficiently blue polyester prepolymer. Preferably, the indirect color compensation also compensates for the yellowing of the thermal treatment steps to which the mixture is exposed during production and processing.

In a further embodiment according to the invention, a clearly negative BM value can be achieved by compensating for yellowing of the recycled polyester material (i.e. BR is above 0) by mixing it with a strong blue polyester prepolymer and there still being an excess of blue toner.

An optical brightener can be added to compensate for any gray tint resulting from the color compensation.

It has been shown that the coloring additive with a negative b* value can be added to the process chain for producing the polyester prepolymer without additional contamination or influencing the product specification (in particular molecular weight), since a monomer for producing the prepolymer melt, preferably ethylene glycol, can act as an additive carrier or no color additive carrier is required at all.

The production of a solid mixture with a desired b* value (BM) of BM<0 from recycled polyester material and a polyester prepolymer from a polyester manufacturing process is difficult, as described above, because recycled polyester material usually has a b* value (BR) of BR>0 due to impurities. This positive b* value due to yellowing must be compensated for by a colorant with a negative b* value.

However, the coloring additive with a negative b* value can only be added to the recycled polyester material using a specific additive carrier. Additive carriers are substances that are used as a carrier material to facilitate the introduction of coloring additives during the extrusion of rPET flakes or in the preform manufacturing process. The addition of a colorant requires the provision of the colorant as a suspension in a liquid additive carrier. This additive carrier must fulfill various requirements. It must be sufficiently temperature-stable to withstand the process steps for producing the solid mixture described above without decomposing. It must be liquid at the processing temperature of the polyester and miscible with the polyester in order to achieve the most homogeneous possible distribution of the colorant in the polyester and, finally, it must not affect the molecular weight of the polyester, as otherwise the quality or specification of the solids mixture would be affected.

In the prior art, therefore, substances such as high-boiling mineral oils or other organic substances were used, usually as liquids at room temperature, which do not decompose at the processing temperatures of PET, typically from 260-310° C., do not lead to the formation of bubbles and do not result in any undesirable side reactions.

The colorant suspended in the color additive carrier was usually added to the recycled polyester material or the solid mixture, i.e. a substance that exhibits the undesirable color deviation.

Regardless of where the color additive carrier with suspended colorant is added, it subsequently remains in the product, which leads to additional contamination of the material. Such additive carriers remain as a component in the rPET material, particularly when recycling PET articles, and lead to undesirable accumulation during repeated recycling cycles.

This problem has led to a conduct that in the manufacture of polyester mass products such as PET bottles, a colorant suspended in a color additive carrier has only been added to the process cycle with great reluctance, if at all.

This problem is solved by the above invention. It was found that a colorant can be added to the process chain for producing the polyester prepolymer, i.e. before the prepolymer or the polymer has formed, without the need for a color additive carrier that would lead to contamination of the polyester stream. In cases where, depending on the colorant used, a color additive carrier must be used, it was found according to the invention that a monomer of the polyester to be produced can be used as the carrier.

In the case of the production of polyethylene terephthalate (PET), the monomer ethylene glycol is preferably used as a carrier. This monomer is then incorporated into the polyester and a polyester of the desired quality or specification is obtained. If a colorant suspended in monomer were to be added to the polyester prepolymer or polyester, the monomer would react with the polyester prepolymer or polyester and change its quality or specification.

The present invention therefore solves the above contamination problem by not adding the colorant to the recycled polyester material or the solid mixture or end product, which would require the use of a color additive carrier that would contaminate or affect the product specification (such as molecular weight). Instead, the colorant is added to the reaction mixture for producing fresh polyester material. Adding a colorant to the process chain for producing the fresh polyester prepolymer is also not an obvious variant, since on the one hand it requires the addition of the colorant to the component that does not require any correction of the color value (in contrast to the yellowed recyclate), and on the other hand the colorant added to this process chain remains in the reaction system for a longer period of time (the further conversion of the entire polyester prepolymer produced requires several hours) and leads to a correspondingly colored product over this period of time. According to the invention, it was found that this can not only be tolerated in the present process, but even leads to a desirable result.

According to a preferred embodiment according to the invention, a coloring additive having a negative b* value is thus added to the polyester prepolymer from a polyester manufacturing process prior to combining with the recycled polyester material, in the process chain for producing the polyester prepolymer, wherein the coloring additive is added to the polyester prepolymer from a polyester manufacturing process without prior dilution or as part of an additive mixture further comprising a monomer of the polyester, and no coloring additive having a negative b* value is added to the recycled polyester material prior to combining with the polyester prepolymer from a polyester manufacturing process.

According to the invention, it is preferred that the coloring additive is dissolved or suspended in the monomer of the polyester.

According to the invention, this concept can also be used independently of the additional purification of the melt described above by removing solid impurities to obtain a purer recycled polyester material.

The present invention thus also relates to a process for producing a polyester solid mixture by adding together a proportion of recycled polyester material and a proportion of polyester material from a polyester manufacturing process, wherein the proportion of recycled polyester material in the polyester solid mixture comprises 10-90% and has a b* value (BR), and the proportion of polyester material from a polyester manufacturing process in the polyester solid mixture comprises 90-10% and has a b* value (BN), and wherein the resulting polyester solids mixture has a b* value (BM), characterized in that BM<0, BN<0 and BR>BN.

According to the invention, it is preferred that BN is <−3, preferably <−5, and even more preferably <−8.

It is further preferred according to the invention that the proportion of recycled polyester material comprises >20%, preferably >25% and particularly preferably >40%, relative to the total polyester solid mixture.

In this process, preferably, analogous to the embodiment described above, a coloring additive having a negative b* value is added to the polyester material from a polyester manufacturing process prior to combining with the recycled polyester material in the process chain for producing the polyester prepolymer, wherein the coloring additive is added to the polyester material from a polyester manufacturing process without prior dilution or as part of an additive mixture which further comprises a monomer of the polyester, and no coloring additive having a negative b* value is added to the recycled polyester material prior to combining with the polyester material from a polyester manufacturing process.

This process can be carried out as described above with or without additional purification of the melt by removing solid impurities to obtain a purer recycled polyester material. In the variant with such additional purification, the process is carried out as described above, but with the addition of a coloring additive to the process chain for producing the polyester prepolymer. In the variant without such additional purification, the process is carried out in a modified manner such that a coloring additive is added to the process chain for producing the polyester prepolymer, but the melt of recycled polyester material is not additionally purified. In this variant, it is therefore not necessary to provide a further unit for removing solid impurities while obtaining a purer recycled polyester material. The provision of a second melt valve is also not necessary with this variant.

The solid mixture produced according to the invention is then treated in a reactor for the thermal treatment of bulk materials with a process gas in counterflow or crossflow to the flow direction of the mixture. This applies to the variant with or without additional purification of the melt by removing solid impurities to obtain a purer recycled polyester material.

According to the invention, the thermal treatment may be selected from the list consisting of drying, crystallization, dealdehydization, solid phase post-condensation, and combinations thereof. According to the invention, the intrinsic viscosity of the polyester solids mixture is preferably increased by at least 5%, preferably by at least 7% and particularly preferably by at least 10% during solid phase post-condensation.

Depending on the type of thermal treatment, the solid mixture must first undergo crystallization. This is well known from the state of the art (see Scheirs/Long (eds.), Modern Polyesters, Wiley 2003).

The solid mixture subjected to thermal treatment can then be formed into the desired shape using known forming processes. Examples include a blow extrusion process for the production of bottles or an injection molding process. It is also possible to melt the solid mixture (e.g. the pellets) and transfer the melt into a film followed by re-forming the film, or by pressing the solid mixture (e.g. the pellets) in a shaping tool.

As described above, in order to obtain a formed article with a desired blue color, it is advantageous for a coloring additive to be added to the process chain for producing the polyester prepolymer in order to compensate for an undesirable color of the polyester recyclate. The addition of such a coloring additive during the forming process is not necessary and undesirable for the reasons described above.

Thus, the present invention also relates to a process for producing a formed article comprising forming a formed article from a polyester solid mixture produced according to one of the processes described above, wherein no coloring additive having a negative b* value is added during the forming of the formed article and the formed article has a b* value (BF) wherein BF<0.

According to the invention, it is preferred that BF is <−2, more preferably <−3 and particularly preferably <−5.

A preferred embodiment according to the invention provides for a dark blue colored formed article to be produced from a mixture of solids consisting of a dark blue colored polyester material and a recyclate which is at least partially produced from dark blue colored formed articles. The addition of a blue coloring additive in the manufacturing process of the formed article can be dispensed with or at least greatly reduced.

Process gases with a low oxygen content, such as nitrogen, carbon dioxide, inert gases, water vapor or mixtures of these gases, are used for the thermal treatment of bulk materials. Such process gases are usually referred to as inert gases. Inert gases are used in particular when the bulk materials are oxygen-sensitive bulk materials.

Bulk materials are referred to as oxygen-sensitive bulk materials if the bulk materials change more during thermal treatment due to the effect of oxygen than would be the case with thermal treatment without oxygen. Such changes can, for example, lead to discoloration, the formation of degradation products and/or a reduction in the molecular weight of the bulk material.

Despite the term inert gas, the process gas may contain small amounts of oxygen, wherein this oxygen may have penetrated the process gas due to leaks, for example, or may have remained in the process gas due to incomplete combustion.

A thermal treatment process for bulk materials is any process in which bulk materials are treated under the influence of a process gas for a certain residence time at a certain temperature. Residence time and temperature can be varied over a very wide range, wherein residence times of a few minutes to several hundred hours and temperatures between the boiling temperature of the process gas and the melting or decomposition temperature of the bulk material are conceivable.

Thermal treatment usually takes place in a treatment chamber that can accommodate the bulk material and the process gas. The corresponding treatment chamber is usually formed by reactors. Suitable reactors can be conical or cylindrical, with a round or rectangular cross-section. Suitable reactors have at least one inlet opening and one discharge opening for the bulk material and at least one inlet opening and one discharge opening for the process gas. The reactors can have various internal elements for influencing the product flow and/or gas flow.

The effect of the process gas is such that organic substances from the polymer are absorbed by the process gas and discharged from the treatment chamber.

Thermal treatment is preferably carried out continuously or semi-continuously, with both the process gas and the bulk material being fed to the reactor either continuously or in individual batches that are smaller than the reactor volume. The process gas is fed either in cross-flow or counter-flow to the flow direction of the bulk material. A preferred embodiment provides for continuous thermal treatment in a moving bed reactor in counterflow.

Alternatively, a discontinuous mode of operation is also conceivable, in which process gas flows through a given amount of bulk material in a reactor.

The size of the reactors is determined by the requirements of the thermal treatment (residence time and throughput). Examples of corresponding reactors are known from EP-2 398 598 A1.

The organic substances that are absorbed by the process gas include any organic substances that are released from the bulk material during the thermal treatment of a bulk material and are present in gaseous form or dissolved in the process gas. If the bulk material is a polymer, the organic substances mainly comprise residues from the polymerization process, decomposition products from the polymer and the additives contained in the polymer, as well as impurities that were introduced into the treatment process together with the polymers and their decomposition products. The organic substances are usually hydrocarbons, which may contain foreign atoms such as nitrogen, phosphorus, sulfur, chlorine, fluorine or metallic complexing agents.

At least part of the process gas is recirculated. For this purpose, process gas is fed from the treatment chamber, preferably a reactor, for the thermal treatment of a bulk material, to a catalytic combustion and then returned to the treatment chamber. This circulation process with purification of the process gas is described in EP-3 865 529 A1.

Here, the process for cleaning a process gas from a thermal treatment process of bulk materials comprises at least one step of catalytic combustion.

The contaminated process gas can undergo further process steps before catalytic combustion, such as an increase in pressure, a process step for separating solid impurities, for example by means of a cyclone separator and/or a filter, mixing with the supplied oxygen-containing gas, for example by means of a static mixer, and heating to increase the temperature to a suitable combustion temperature, for example by means of a heat exchanger for heat recovery and/or by means of a process gas heater.

If necessary, the catalyst bed can also be heated directly, for example by external heat sources or by the combustion heat of the impurities.

After catalytic combustion, the purified process gas can undergo further process steps, such as cooling, drying, increasing pressure, a process step for separating solid impurities, for example by means of a cyclone separator and/or a filter, heating and mixing with additives or other process gas streams.

Adsorption steps for removing so-called catalyst poisons are known in the state of the art. Catalyst poisons are generally known to be inorganic substances that are deposited on the surface of the catalyst material and thus lead to direct deactivation of the catalyst for catalytic combustion. Common catalyst poisons are halogens, sulfur and heavy metals. The catalyst poisons can be adsorbed on the adsorption material or on an adsorbent coating on a carrier material. Common adsorbent coatings are bases such as sodium hydroxide, potassium hydroxide or calcium oxide, as well as sodium or potassium carbonates.

Such adsorption materials are also suitable for removing high-boiling organic substances or organic substances with a high combustion temperature. Such substances lead to deactivation of the catalyst for catalytic combustion in the event of incomplete combustion. High-boiling hydrocarbons in particular have a deactivating effect, as they can lead to carbon deposits on the catalyst material in the event of incomplete combustion or directly clog the pores of the carrier material on which the catalyst material is applied.

According to one embodiment of the present invention, prior to catalytic combustion, the contaminated gas undergoes a step of adsorption of high boiling organic substances or organic substances with high combustion temperature on a solid adsorption material in a protective bed.

The protective bed can be designed as a surface coated with an adsorption material. Preferably, however, the protective bed consists of a solid material in bulk form, which can consist entirely of an adsorption material or can be coated with an adsorption material. The protective bed is preferably located in an adsorption container. The process gas flows through the adsorption container in any direction and flows through the adsorption bed, but preferably in a direction from a specific inlet side to a specific outlet side. The inlet side can be located at the top or bottom of the adsorption tank. If liquid substances are to be removed, an arrangement of the inlet side at the bottom of the adsorption tank is preferred so that the gas flows through the protective bed from bottom to top. The liquid residue can be led out of the adsorption tank through a valve, for example. If sublimable substances are to be removed, an arrangement of the inlet side at the top of the adsorption vessel is preferred so that the gas flows through the protective bed from top to bottom. The top layer with sublimated residue can then be removed.

The protective bed material can be placed on a separating element, which allows gas but no protective bed material to pass through, in the central part of the adsorption vessel. The separating element is usually a sieve, which is arranged in the adsorption vessel in such a way that all process gas must flow through the sieve and the protective bed located on it. Preferably, the sieve can be heated to prevent deposits.

In addition to the openings for the inlet and outlet of the process gas, the adsorption container can have further openings. Preferably, an outlet opening for the protective bed material from the adsorption container can be arranged in the lower part of the adsorption container, and/or an outlet opening for the protective bed material from the adsorption container can be arranged in the middle part, and/or a feed opening for fresh or returned protective bed material can be arranged in the upper part of the adsorption container. Furthermore, inlet and outlet openings for purge gas, in particular inert gas, can be provided in order to remove oxygen from the protective bed material. Furthermore, an opening for sampling the protective bed material can be arranged in the central part of the adsorption container.

According to an alternative embodiment, the separating element can be conical and connected to a lockable outlet opening for the protective bed material from the adsorption container, so that the protective bed material can be emptied from the adsorption container by opening the outlet opening.

According to a further alternative embodiment, the complete or partial emptying of the protective bed material from the adsorption container can be carried out in such a way that heavily contaminated protective bed material can be separated from less contaminated protective bed material and the less contaminated protective bed material is returned to the adsorption container.

The protective bed can be selected in such a way that it chemically binds substances from the process gas or that it physically accumulates substances from the process gas.

The inlet temperature of the process gas into the adsorption tank can cover a wide range. However, it must be high enough to ensure any necessary chemical reactions and low enough to allow sufficient accumulation of substances to be physically bound.

In particular, the temperature is set in such a way that high-boiling substances condense and can be absorbed by the adsorption material. If the process gas contains water, the temperature is selected in such a way that no condensation of water occurs in the protective bed. For the treatment of thermoplastic polycondensates, present as virgin material or as recyclate, the preferred temperature is in the range from 100 to 250° C., more preferably above 120° C. and particularly preferably below 170° C., especially preferably from 120° C. to 170° C.

To adjust the temperature, the process gas can be heated or usually cooled using heat exchangers. Cooling is preferably carried out in double-jacket tubes or tube bundle heat exchangers in order to avoid deposits of condensing substances.

The contact time of the process gas in the protective bed ranges from a tenth of a second to several minutes. Contact times in the range of 2 to 20 seconds are preferred.

The cross-sectional area of the protective bed is selected in such a way that a linear velocity of the process gas or a superficial velocity (operating volume flow/protective bed fill cross-section in the direction of flow of the gas) in a range of approximately 0.05 to 3 m/s results, with a pressure loss of 10 mbar to 200 mbar, in particular 20 mbar to 100 mbar. The layer thickness of the protective bed should be constant over its entire cross-section and be in a ratio of 10:1 to 1:10 to the diameter of the protective bed filling.

In particular, the adsorption material is selected in such a way that high-boiling substances are removed from the process gas, wherein at least a reduction to below 20%, preferably to below 10% of their initial value in the process gas should take place.

Examples of adsorption materials that can be used are zeolites, silica gels, activated carbon, activated aluminum oxide and aluminum dioxide.

The present invention further relates to an apparatus for producing and processing a mixture of recycled polyester material and a polyester prepolymer from a polyester manufacturing process, comprising
a first reactor for providing polyester prepolymer from a polyester manufacturing process in the form of a melt;
a second reactor for providing recycled polyester material in the form of a melt;
a first filter unit for cleaning the melt of recycled polyester material, which is arranged downstream of the second reactor;
a unit for producing a solid mixture of recycled polyester material and a polyester prepolymer from a polyester manufacturing process, preferably a first particle forming device; Wherein a first melt valve is arranged between the first reactor and the unit for producing the solid mixture, and a melt line and optionally a second melt valve is arranged between the first filter unit and the first melt valve, which melt line is connected to the first filter unit via a first section of the melt line and to the first melt valve via a second section of the melt line;
a reactor for the thermal treatment of the solid mixture of recycled polyester material and a polyester prepolymer from a polyester manufacturing process with a process gas which can be fed to the solid mixture in counterflow or crossflow to the flow direction of the mixture;
characterized in that a further unit is provided for removing solid impurities to obtain a purer recycled polyester material, which is selected from the group consisting of a second filter unit, a second particle forming device, and combinations thereof,
wherein a melt filter whose openings have an average size which is larger than the average size of the openings of the melt filter used in the first filter unit is used as the second filter unit, and the second filter unit is provided at a position selected from the group consisting of a position between the first melt valve and the unit for producing a solid mixture, and a position after the first filter unit and before and the first melt valve, and
wherein the second particle forming device is connected to the second melt valve, wherein the first melt valve and the second melt valve are designed to be switchable so that
in a first switching arrangement in the first melt valve all melt lines are unblocked, and in the second melt valve the section of the melt line coming from the first filter unit is blocked and the section of the melt line leading to the first melt valve and the melt line leading to the second particle forming device are unblocked,
in a second switching arrangement, in the first melt valve all melt lines are unblocked, and in the second melt valve the section of the melt line coming from the first filter unit and the section of the melt line leading to the first melt valve are unblocked and the melt line leading to the second particle forming device is blocked,
in a third switching arrangement, in the first melt valve the melt line coming from the first reactor and the line leading to the unit for producing a solid mixture are unblocked and the section of the melt line leading to the second melt valve is blocked, and in the second melt valve the section of the melt line leading to the first melt valve is blocked and the section of the melt line coming from the first filter unit and the melt line leading to the second particle forming device are unblocked,
in a fourth switching arrangement, in the first melt valve and the second melt valve all melt lines are unblocked.

According to the invention, conventional plants for the thermal treatment of a bulk material can be converted into an apparatus according to the invention, in which one of the processes according to the invention can be carried out.

The present invention thus also relates to a process for retrofitting a plant for producing and thermally treating a bulk virgin material, preferably for producing and post-condensing polyester pellet virgin material, into a plant for producing and thermally treating polyester pellets comprising at least partially recycled material, which comprises at least partially re-pelletized polyester recyclate,
wherein the plant includes:
a first reactor for providing polyester prepolymer from a polyester manufacturing process in the form of a melt;
a unit for producing a solid, preferably a first particle forming device;
a reactor for the thermal treatment of the solid material from recycled polyester material and a polyester prepolymer from a polyester manufacturing process with a process gas which can be fed to the solid material mixture in counterflow or crossflow to the flow direction of the mixture;
   characterized in that the plant is additionally equipped with:
a second reactor for providing recycled polyester material in the form of a melt;
a first filter unit for cleaning the melt of recycled polyester material, which is arranged downstream of the second reactor;
a first melt valve between the first reactor and the unit for producing the solid mixture;
optionally a second melt valve between the first filter unit and the first melt valve, which is connected to the first filter unit via a first section of the melt line and to the first melt valve via a second section of the melt line;
a further unit for removing solid impurities to obtain a purer recycled polyester material, which is selected from the group consisting of a second filter unit, a second particle forming device, and combinations thereof, wherein the second filter unit is a melt filter whose openings have an average size larger than the average size of the openings of the melt filter used in the first filter unit, and the second filter unit is provided at a position selected from the group consisting of a position between the first melt valve and the unit for producing a solid mixture, and a position after the first filter unit and before the first melt valve, and
   wherein the second particle forming device is connected to the second melt valve, the first melt valve and the second melt valve being designed to be switchable, so that
   in a first switching arrangement, in the first melt valve all melt lines are unblocked, and in the second melt valve the section of the melt line coming from the first filter unit is blocked and the section of the melt line leading to the first melt valve and the melt line leading to the second particle forming device are unblocked,
   in a second switching arrangement, in the first melt valve all melt lines are unblocked, and in the second melt valve the section of the melt line coming from the first filter unit and the section of the melt line leading to the first melt valve are unblocked and the melt line leading to the second particle forming device is blocked,
   in a third switching arrangement, in the first melt valve the melt line coming from the first reactor and the line leading to the unit for producing a solid mixture are unblocked and the section of the melt line leading to the second melt valve is blocked, and in the second melt valve the section of the melt line leading to the first melt valve is blocked and the section of the melt line coming from the first filter unit and the melt line leading to the second particle forming device are unblocked,
   in a fourth switching arrangement in the first melt valve and the second melt valve, all melt lines are unblocked.

### BRIEF DESCRIPTION OF THE DRAWINGS

The present invention is explained in more detail below with reference to non-limiting examples and drawings. It shows:

FIG. 1 a schematic view of a plant according to the invention according to a first embodiment

FIG. 2 a schematic view of a plant according to the invention according to a second embodiment

FIG. 3 a schematic view of a plant according to the invention according to a third embodiment

FIG. 4 a schematic view of an installation according to the invention according to a fourth embodiment

FIG. 5 a schematic view of a plant according to the invention according to a fifth embodiment

FIG. 6 a schematic view of a plant according to the invention according to a sixth embodiment

FIG. 7 a schematic view of a plant according to the invention according to a seventh embodiment

FIG. 8 a schematic view of a plant according to the invention according to an eighth embodiment.

### DETAILED DESCRIPTION OF THE PREFERRED EMBODIMENTS

In the figures, the same reference signs denote the same components.

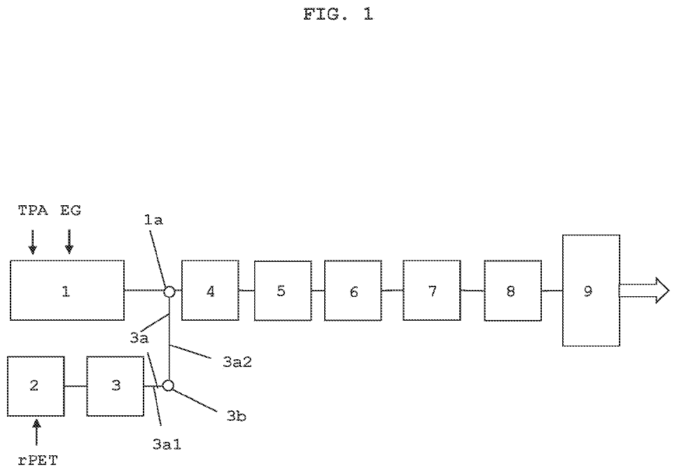

FIG. 1 shows a schematic view of a plant according to the invention in accordance with a first embodiment.

In a first reactor 1, a slurry is produced from the corresponding monomers, in the case of PET the monomers terephthalic acid (TPA) and ethylene glycol (EG), and then subjected to esterification, prepolymerization and melt polymer condensation in a finisher. A prepolymer melt, for example of virgin PET (vPET), leaves the first reactor 1 and reaches a first melt valve 1a. The polyester production process can also be carried out in a series of reactors, in which case the reactor in which the polyester prepolymer ultimately used as the starting material of the process according to the invention is produced is referred to as first reactor 1. Polyester production processes and suitable reactors for this purpose are sufficiently known in the prior art (e.g. Scheirs/Long (eds.), Modern Polyesters, Wiley 2003, 11.2.4, pp. 89-98).

In one embodiment in which a coloring additive is added, the coloring additive can be introduced into reactor 1, or if the polyester manufacturing process is carried out in a series of reactors, into any of these reactors.

Polyester recyclate, preferably PET recyclate (rPET, preferably PET flakes) is introduced into a second reactor 2, preferably an extruder, where it is melted and extruded. The melt of polyester recyclate, preferably rPET, is fed into a first filter unit 3 (melt filter) where it is cleaned of solid impurities. The purified melt of polyester recyclate, preferably rPET melt, is then fed via a melt line 3a to the first melt valve 1a, where it is combined with the prepolymer melt of polyester prepolymer, preferably “virgin” PET. A second melt valve 3b can preferably be arranged in the melt line 3a for the melt of polyester recyclate, preferably rPET melt, in order to prevent the introduction of contaminated or poor-quality melt of polyester recyclate, preferably rPET melt. The second melt valve 3b is connected to the first filter unit 3 via a first section 3a1 of the melt line 3a and to the first melt valve 1a via a second section 3a2 of the melt line 3a. In addition, at least one unit for measuring a quality parameter can be arranged in the melt line 3a for the melt of polyester recyclate, preferably rPET melt.

The melt mixture combined in the first melt valve 1a is then mixed in an optional mixing unit 4, in this case a static mixer, and then pelletized in a unit for producing a solid 6, in this case a pelletizer (preferably an underwater pelletizer or underwater strand pelletizer), dried if necessary and brought to a desired degree of crystallization in a crystallizer 7. The partially crystalline polyester pellet mixture, preferably PET pellet mixture, is heated in a preheater 8 to a temperature required for the SSP reaction and subjected to an SSP reaction in the reactor 9 for thermal treatment. The finished polyester mixture, preferably PET mixture, leaves the reactor 9 with the desired intrinsic viscosity and can optionally be cooled, transported and/or stored and then processed further.

The plant according to FIG. 1 is characterized by the fact that a second filter unit 5 is arranged between the mixing unit 4 and the unit for producing a solid material 6. In the second filter unit 5, solid impurities are removed while obtaining a purer recycled polyester material. The second filter unit 5 comprises a melt filter whose openings have an average size which is larger than the average size of the openings of the melt filter used in the first filter unit 3.

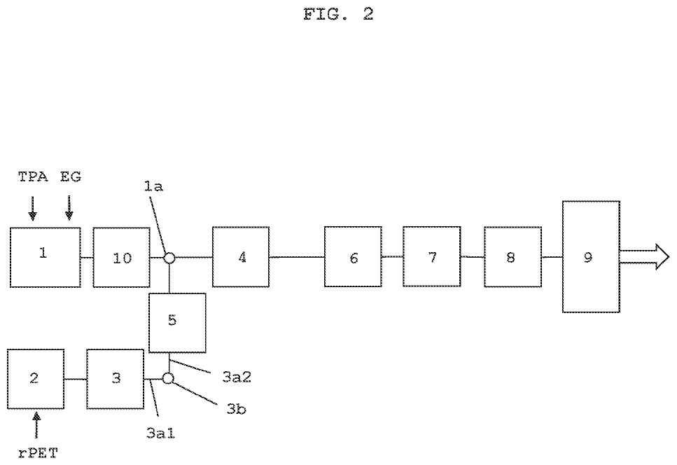

FIG. 2 shows a schematic view of a plant according to the invention in accordance with a second embodiment. The plant according to FIG. 2 differs from the plant according to FIG. 1 in that the second filter unit 5 is arranged between the second melt valve 3b and the first melt valve 1a. In addition, a third filter unit 10 is arranged between the first reactor and the first melt valve.

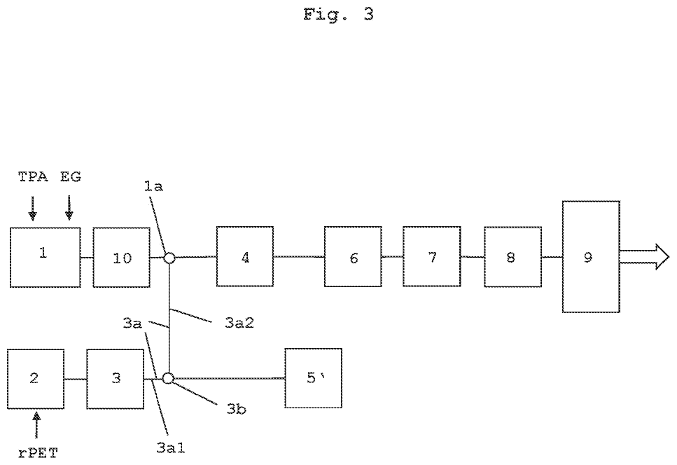

FIG. 3 shows a schematic view of a plant according to the invention in accordance with a third embodiment. The plant according to FIG. 3 differs from the plant according to FIG. 1 in that a second particle forming device 5′ for producing a solid is provided as a further unit for removing solid impurities while obtaining a purer recycled polyester material—instead of a second filter unit 5. The second particle forming device 5′ for producing a solid is here a pelletizer (preferably an underwater pelletizer or underwater strand pelletizer), which is connected to the second melt valve 3b.

The plant according to FIG. 3 has switchable melt valves 1a, 3b and can be operated in various switching arrangements as described above. In a first switching arrangement, polyester prepolymer melt can pass from the first reactor 1 through an optionally arranged third filter unit 10, through the first melt valve 1a, the second section 3a2 of the melt line 3a and the second melt valve 3b into the second particle forming device 5′ to produce a solid. In a second switching arrangement, polyester recyclate melt can pass from the second reactor 2 through the first filter unit 3, the first section 3a1 of the melt line 3a, the second melt valve 3b, the second section 3a2 of the melt line 3a and the first melt valve 1a into the unit 6 for producing a solid. In a third switching arrangement, polyester recyclate melt can pass from the second reactor 2 through the first filter unit 3, the first section 3a1 of the melt line 3a and the second melt valve 3b into the second particle forming device 5′ to produce a solid.

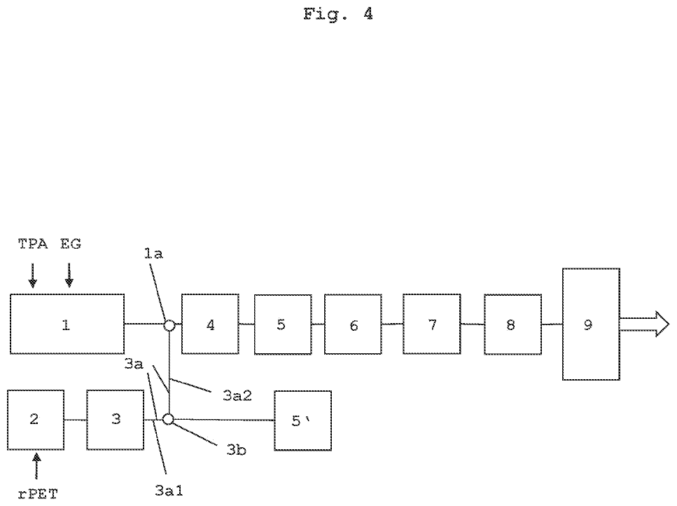

FIG. 4 shows a schematic view of a plant according to the invention in accordance with a fourth embodiment. The plant according to FIG. 4 differs from the plant according to FIG. 3 in that a second filter unit 5 is additionally arranged between the mixing unit 4 and the unit for producing a solid 6. The optional third filter unit 10 is omitted here.

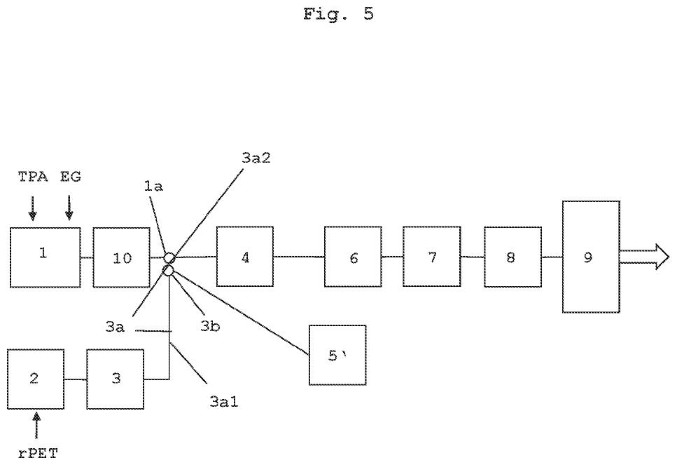

FIG. 5 shows a schematic view of a plant according to the invention in accordance with a fifth embodiment. The plant according to FIG. 5 differs from the plant according to FIG. 3 in that the second melt valve 3b is arranged in direct proximity to the first melt valve. If the melt line from the first filter unit 3 and the melt line to the second particle forming device 5′ are unblocked in the second melt valve 3b, melt made of polyester recyclate, preferably PET recyclate, can be fed through the first filter unit 3 and the melt line 3a into the second particle forming device 5′ to produce a solid. Here, the melt of polyester recyclate, preferably PET recyclate, carries impurities from the entire line system 3a1 between the second reactor 2 and the second melt valve 3b out of the plant. It is not necessary to purge the very short melt line 3a2 between the first melt valve 1a and the second melt valve 3b with polyester prepolymer melt, preferably virgin PET (vPET). Particularly preferred for this embodiment is a piston valve for shutting off the melt of polyester recyclate, preferably PET recyclate, wherein the shut-off piston in the closed state displaces a large part of the volume of the melt line between the second melt valve 3b and the point in the first melt valve 1a at which the melt streams are combined.

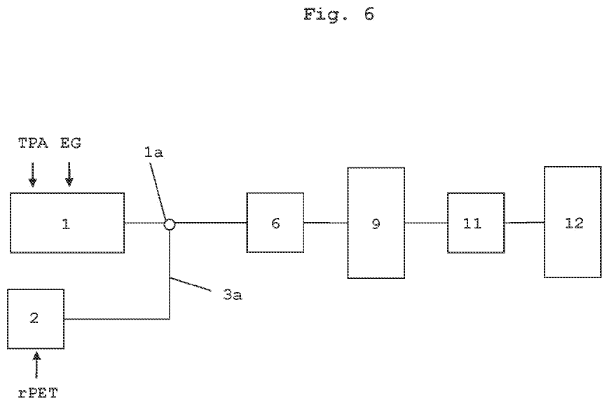

FIG. 6 shows a schematic view of a plant according to the invention in accordance with a fifth embodiment. In a first reactor 1, a slurry is produced from the corresponding monomers, in the case of PET the monomers terephthalic acid (TPA) and ethylene glycol (EG), and then subjected to esterification, prepolymerization and melt polymer condensation in a finisher. A prepolymer melt, for example of “virgin” PET (vPET), leaves the first reactor 1 and reaches a first melt valve 1a.

The polyester production process can also be carried out in a series of reactors, in which case the reactor in which the polyester prepolymer ultimately used as the starting material of the process according to the invention is produced is referred to as the first reactor 1. Polyester production processes and suitable reactors for this purpose are sufficiently known in the prior art (e.g. Scheirs/Long (eds.), Modern Polyesters, Wiley 2003, 11.2.4, pp. 89-98).

In one embodiment in which a coloring additive is added, the coloring additive may be introduced into reactor 1, or if the polyester manufacturing process is carried out in a series of reactors, into any of these reactors.

Polyester recyclate, preferably PET recyclate (rPET, preferably PET flakes), is introduced into a second reactor 2, preferably an extruder, where it is melted and extruded. Optionally, the melt of polyester recyclate, preferably rPET, is fed into a first filter unit (melt filter, not shown) where it is cleaned of solid impurities. The polyester recyclate melt, preferably rPET melt, is then fed via a melt line 3a to the first melt valve 1a, where it is combined with the polyester prepolymer melt, preferably of “virgin” PET. A second melt valve (not shown) can optionally be arranged in the melt line 3a for the polyester recyclate melt, preferably rPET melt, in order to prevent the introduction of contaminated or poor-quality polyester recyclate melt, preferably rPET melt. In addition, at least one unit for measuring a quality parameter can be arranged in the melt line 3a for the polyester recyclate melt, preferably rPET melt.

The melt mixture combined in the first melt valve 1a is then mixed in an optional mixing unit (not shown) and then pelletized in a unit for producing a solid 6, in this case a pelletizer (preferably an underwater pelletizer or underwater strand pelletizer) and, if necessary, dried.

Optionally, the melt of polyester recyclate, preferably rPET, can be cleaned of solid impurities in a second filter unit (melt filter, not shown). Also optionally, the melt of polyester prepolymer, preferably vPET, can be cleaned of solid impurities in a second filter unit (melt filter, not shown).

The polyester pellet mixture, preferably PET pellet mixture, is optionally brought to a desired degree of crystallization in a crystallizer (not shown). The partially crystalline polyester pellet mixture, preferably PET pellet mixture, is optionally heated in a preheater (not shown) to a temperature required for thermal treatment and subjected to thermal treatment in the reactor 9. The thermal treatment includes processes to remove volatile components and processes of an SSP reaction. The finished polyester mixture, preferably PET mixture, leaves the reactor 9 with the desired intrinsic viscosity and purity and can optionally be cooled, transported and/or stored and then further processed.

The plant according to FIG. 6 can be used if it is desired to provide a formed body which has a b* value (BF), where BF<0. A coloring additive with a negative b* value is preferably added here to the reaction mixture for producing the polyester prepolymer in the first reactor 1 or at any point in a first series of reactors. No further addition of a coloring additive with a negative b* value is carried out in the plant. The solid mixture produced in the unit for producing a solid 6 is then fed to the first reactor 9 for thermal treatment and to a further reactor 11 for thermal treatment, where it is subjected to drying, for example. Subsequently, the polyester solid mixture, preferably PET solid mixture, is formed into a desired formed article in a unit 12 for producing a formed article. The formed article is usually produced by melting the polyester solids mixture, preferably PET solids mixture.

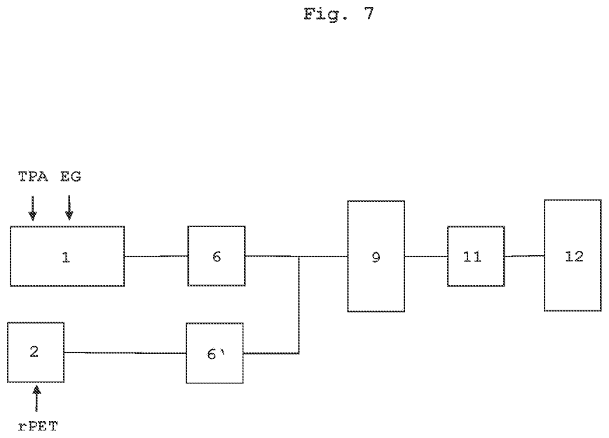

FIG. 7 shows a schematic view of a plant according to the invention according to a sixth embodiment. The plant according to FIG. 7 differs from the plant according to FIG. 6 in that the polyester recyclate melt leaving the second reactor 2 enters a pelletizer 6′ (further unit for producing a solid mixture) and is combined with the polyester prepolymer pellets, preferably virgin PET pellets, from the pelletizer 6. The first melt valve 1a and the melt line 3a are omitted. The remaining steps are identical.

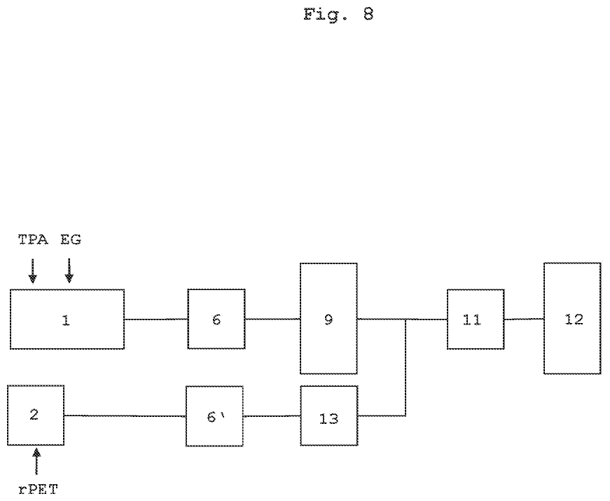

FIG. 8 shows a schematic view of a plant according to the invention in accordance with a seventh embodiment. The plant according to FIG. 8 differs from the plant according to FIG. 7 in that the polyester recyclate converted into a solid in the pelletizer 6′ is first processed in a third reactor 13 for thermal treatment, in this case solid phase post-condensation (SSP) or dealdehydization, before it is combined with the vPET, which has also already been subjected to thermal treatment in reactor 9.

### Example 1

In a conventional plant for the production of a polyethylene terephthalate (PET), a slurry was produced from terephthalic acid (TPA) and ethylene glycol (EG). This slurry was then subjected to the steps of esterification, prepolymerization and melt-phase polymerization in a finisher. A blue coloring additive in ethylene glycol was added in the esterification step before the polymerization was completed, as a result of which the polyester prepolymer melt ultimately had a b* value of −4.1. To measure the b* value, the melt was pelletized and crystallized.

A polyester recyclate melt with a b* value of +0.2 was produced from washed PET bottle waste in an extruder. No coloring additive was added to the polyester recyclate melt. The melt was pelletized and crystallized to measure the b* value.

Both melts were subjected to filtration of the melt to remove solid impurities. Sieves with a mesh size of 60 μm were used.

The two product streams are continuously mixed in proportion to their production output (130 t/d of polyester prepolymer and 30 t/d of polyester recyclate) to form a PET solid mixture, and processed into cylindrical, amorphous PET prepolymer pellets (pellet weight approx. 18 mg) by underwater strand pelletization. The pellets were subjected to crystallization in a fluidized bed apparatus, preheating to SSP reaction temperature under inert gas in a roof heat exchanger, and solid phase treatment by solid phase polycondensation (SSP), with the vPET pellets having an IV of 0.62 dl/g before SSP and an IV of 0.82 dl/g after SSP. The PET solid mixture was treated in a continuously operated fixed-bed reactor in countercurrent flow with nitrogen at 204° C. for 12 hours.

The PET solids mixture treated in this way had a b* value of −2.8.

The PET solid mixture was processed into preforms for drinks bottles. No additional coloring additive was added to the PET solid mixture. The preforms continued to have a slight blue tint. Measured in the grounded state, the b* value was −0.3.

In this example, the addition of the coloring additive during vPET production not only compensated for the original yellowing of the rPET, but also for the yellowing that occurs during thermal treatment and preform production. Clearer, almost colorless preforms could be produced without using another coloring additive during preform production.

If the amount of coloring additive added to the process chain for producing the polyester prepolymer was increased further, a PET solids mixture that appeared blue was produced. This in turn could be processed into preforms with a blue appearance without using another coloring additive during preform production.

### Comparative Example 1

A PET solid mixture was produced from 8 t/h vPET and 2 t/h rPET in a device as shown in FIG. 6. Compared to the production of pure vPET, the addition of a solution of blue coloring additive in ethylene glycol to the vPET production process was increased by 10%. Preforms were produced by injection molding, wherein a blue coloring additive had to be added in a liquid additive carrier to produce preforms with a bluish appearance.

### Example 2

Comparative example 1 was repeated, wherein the addition of the solution of blue coloring additive in ethylene glycol in the vPET manufacturing process was increased by a further 3% (i.e. to plus 13%). This resulted in a PET solid mixture with a b* value of −3.2. This PET solids mixture could be processed into preforms with a bluish appearance without adding a blue coloring additive to the injection forming process.

### Comparative Example 2

A PET solids mixture was produced from 8.7 t/h vPET and 1.7 t/h rPET in a device as shown in FIG. 3. The vPET melt was cleaned of solids using a cartridge filter 10 with a nominal screen opening of 56 μm. The rPET melt was cleaned of solids by a piston filter 3 (screen changer with backwash) with a nominal screen opening of 56 μm.

First, the melt valves 1a, 3b were adjusted in such a way that the vPET melt in the main stream was fed to two strand pelletizing units 6 set up in parallel and the rPET melt in the side stream was fed to a separate strand pelletizing unit 5′.

After a start-up phase of one day, the melt valves were adjusted so that the rPET melt was fed to the vPET melt and the mixture was fed to the two parallel pelletizers 6 in the main stream.

Samples of amorphous pellets were taken from all pelletizers every two hours. Averaged over 12 hours, the average amount of black specs was calculated to be in the range of 100-500 μm per kilogram. The values of the two pelletizers operated in parallel in the main stream were averaged.

| | black specs in number per kg | | |
|---|---|---|---|
| Comparative Example 2 | VPET | rPET | Mixture |
| Start up | 1.6 | 14 | Na |
| 0-12 hours after switching | (1.6) | (47) | 9 |
| >48 hours after switching | (1.6) | (19) | 4.3 |

The values in brackets are calculated values assuming that the black spec number in the vPET has not changed after start-up.

In addition, it was observed that black specs with a size of more than 500 μm were found in some samples in the first 12 hours after the switchover. Such impurities were not present before the melt valves were switched. The size of irregularly shaped black specs is assigned as the diameter of a circle of equal area.

Due to this mode of operation, the production of a vPET/rPET solid mixture of good quality could only be achieved after 2 days. Almost 500 tons of PET of inferior quality were produced.

### Example 3

Comparative example 2 was repeated, wherein after start-up the melt valves 1a, 3b were set in such a way that vPET melt was fed to the separate strand pelletizing unit 5′ for two days. After switching the melt valves 1a, 3b to produce the vPET/rPET mixture, a product with a black spec content <5 was obtained directly, wherein the value had reduced even further to 3.9 after 72 hours.

This mode of operation made it possible to produce a good quality vPET/rPET solid mixture immediately after switching the melt valves 1a and 3b. Approx. 80 tons of rPET of inferior quality were produced.

### Example 4

The plant shown in FIG. 3 was supplemented by a further melt filter 5 directly upstream of valve 1a for combining the rPET and vPET melt. This was a continuously operated laser filter with a perforated plate with openings in the 100-120 μm range. Comparative example 2 was repeated, wherein the melt valves 1a, 3b were adjusted after start-up in such a way that a vPET/rPET mixture was produced directly. A product with a black spec content <5 was obtained directly, wherein the value had reduced even further to 2.7 after 72 hours.

This mode of operation made it possible to produce a vPET/rPET solid mixture of good quality immediately after switching the melt valves 1a, 3b. No product of inferior quality was produced.

1. A process for producing and processing a mixture of recycled polyester material and a polyester prepolymer from a polyester manufacturing process, comprising the steps of:
providing a recycled polyester material in the form of a melt and initial purification of the melt by removing solid impurities using melt filtration;
mixing of the recycled polyester material in the form of a melt with a polyester prepolymer in the form of a melt from a polyester manufacturing process and subsequent production of a solid mixture;
treatment of this solid mixture in a reactor for a thermal treatment of bulk materials with a process gas in counterflow or crossflow to a flow direction of the mixture;
wherein at least for a first period after the start of the process, at least one additional step for purifying the melt by removing solid impurities to obtain a purer recycled polyester material is carried out before the solid mixture is produced.

2. The process according to claim 1, wherein the additional step of purifying the melt of the recycled polyester material is carried out by means of melt filtration.

3. The process according to claim 2, wherein the additional step of purifying the melt of the recycled polyester material is carried out by a melt filter whose openings have an average size which is larger than an average size of the openings of the melt filter used in the first purification.

4. The process according to claim 3, wherein the additional step of purifying the melt of the recycled polyester material by means of melt filtration is carried out before the step of mixing the recycled polyester material in the form of a melt with the polyester prepolymer in the form of a melt from a polyester manufacturing process.

5. The process according to claim 3, wherein the additional step of purifying the melt of the recycled polyester material by means of melt filtration is carried out after the step of mixing the recycled polyester material in the form of a melt with the polyester prepolymer in the form of a melt from a polyester manufacturing process.

6. The process according to claim 1, wherein the additional step of purifying the melt of the recycled polyester material is realized by introducing the polyester prepolymer in the form of a melt from a polyester manufacturing process or the recycled polyester material in the form of a melt, in each case with entrainment of deposited impurities from at least one section of a melt line, into a second particle forming device and a production of the solid material with discharge of entrained deposited impurities in the second particle forming device.

7. The process according to claim 6, wherein a further step for purifying the melt of the recycled polyester material is carried out by means of melt filtration, wherein a melt filter is used for the further purification step, the openings of which have an average size which is larger than an average size of the openings of the melt filter used in the first purification, and wherein the further step for purification by means of melt filtration is carried out after the step of mixing the recycled polyester material in the form of a melt with the polyester prepolymer in the form of a melt from a polyester manufacturing process.

8. The process according to claim 1, wherein a proportion of recycled material in the solid mixture comprises 10-90% and has a b* value (BR), and a proportion of polyester prepolymer from a polyester manufacturing process in the solid mixture comprises 90-10% and has a b* value (BN), and wherein the resulting solid mixture has a b* value (BM) and BM<0, BN<0 and BR>BN.

9. The process according to claim 8, wherein a coloring additive having a negative b* value is added to the polyester prepolymer from a polyester manufacturing process prior to combining with the recycled polyester material, the coloring additive being added to the polyester prepolymer from a polyester manufacturing process without prior dilution or as part of an additive mixture further comprising a monomer of the polyester, and no coloring additive having a negative b* value is added to the recycled polyester material prior to combining with the polyester prepolymer from a polyester manufacturing process.

10. An apparatus for producing and processing a mixture of recycled polyester material and a polyester prepolymer from a polyester manufacturing process, comprising
a first reactor for providing polyester prepolymer from a polyester manufacturing process in the form of a melt;
a second reactor for providing recycled polyester material in the form of a melt;
a first filter unit for cleaning the melt of recycled polyester material, which is arranged downstream of the second reactor;
a unit for producing a solid mixture of recycled polyester material and a polyester prepolymer from a polyester manufacturing process;
wherein a first melt valve is arranged between the first reactor and the unit for producing the solids mixture, and a melt line and is arranged between the first filter unit and the first melt valve, which is connected to the first filter unit via a first section of the melt line and to the first melt valve via a second section of the melt line;
a reactor for a thermal treatment of the solid mixture of recycled polyester material and a polyester prepolymer from a polyester manufacturing process with a process gas which can be fed to the solid mixture in countercurrent or crosscurrent to a flow direction of the solid mixture;
wherein a further unit for removing solid impurities to obtain a purer recycled polyester material is provided, which is selected from the group consisting of a second filter unit, a second particle forming device, and combinations thereof,
wherein a melt filter whose openings have an average size larger than an average size of the openings of the melt filter used in the first filter unit is used as the second filter unit, and the second filter unit is provided at a position selected from the group consisting of a position between the first melt valve and the unit for producing a solid mixture, and a position after the first filter unit and before and the first melt valve, and
wherein the second particle forming device is connected to a second melt valve, wherein the first melt valve and the second melt valve are designed to be switchable so that
in a first switching arrangement, in the first melt valve all melt lines are unblocked, and in the second melt valve the section of the melt line coming from the first filter unit is blocked and the section of the melt line leading to the first melt valve and the melt line leading to the second particle forming device are unblocked,
in a second switching arrangement, in the first melt valve all melt lines are unblocked, and in the second melt valve the section of the melt line coming from the first filter unit and the section of the melt line leading to the first melt valve are unblocked and the melt line leading to the second particle forming device is blocked,
in a third switching arrangement, in the first melt valve the melt line coming from the first reactor and the line leading to the unit for producing a solids mixture are unblocked and the section of the melt line leading to the second melt valve is blocked, and in the second melt valve the section of the melt line leading to the first melt valve is blocked and the section of the melt line coming from the first filter unit and the melt line leading to the second particle forming device are unblocked,
in a fourth switching arrangement in the first melt valve and the second melt valve, all melt lines are unblocked.

11. A process for retrofitting a plant for the production and thermal treatment of a bulk virgin material, into a plant for the production and thermal treatment of polyester pellets comprising at least partially recycled material, which comprises at least partially re-pelletized polyester recyclate,
wherein the plant includes:
a first reactor for providing polyester prepolymer from a polyester manufacturing process in the form of a melt;
a unit for producing a solid;
a reactor for a thermal treatment of the solid material of recycled polyester material and a polyester prepolymer from a polyester manufacturing process with a process gas which can be fed to the solid material mixture in counterflow or crossflow to a flow direction of the mixture;
wherein the plant is additionally equipped with:
a second reactor for providing recycled polyester material in the form of a melt;
a first filter unit for cleaning the melt of recycled polyester material, which is arranged downstream of the second reactor;
a first melt valve between the first reactor and the unit for producing the solids mixture;
a further unit for removing solid impurities to obtain a purer recycled polyester material, which is selected from the group consisting of a second filter unit, a further unit for producing a solid, and combinations thereof, wherein as the second filter unit a melt filter is used, the openings of which have an average size which is larger than an average size of the openings of the melt filter used in the first filter unit, and the second filter unit is provided at a position selected from the group consisting of a position between the first melt valve and the unit for producing a solid mixture, and a position after the first filter unit and before the first melt valve, and
wherein the second particle forming device is connected to a second melt valve, wherein the first melt valve and the second melt valve are designed to be switchable, so that
in a first switching arrangement, in the first melt valve all melt lines are unblocked, and in the second melt valve the section of the melt line coming from the first filter unit is blocked and the section of the melt line leading to the first melt valve and the melt line leading to the second particle forming device are unblocked,
in a second switching arrangement, in the first melt valve all melt lines are unblocked, and in the second melt valve the section of the melt line coming from the first filter unit and the section of the melt line leading to the first melt valve are unblocked and the melt line leading to the second particle forming device is blocked,
in a third switching arrangement, in the first melt valve, the melt line coming from the first reactor and the line leading to the unit for producing a solids mixture are unblocked and the section of the melt line leading to the second melt valve is blocked, and in the second melt valve, the section of the melt line leading to the first melt valve is blocked and the section of the melt line coming from the first filter unit and the melt line leading to the second particle forming device are unblocked,
in a fourth switching arrangement in the first melt valve and the second melt valve, all melt lines are unblocked.

12. A process for producing a polyester solid mixture by adding together a proportion of recycled polyester material and a proportion of polyester material from a polyester manufacturing process, wherein the of recycled polyester material in the polyester solid mixture comprises 10-90% and has a b* value (BR), and the proportion of polyester material from a polyester manufacturing process in the polyester solid mixture comprises 90-90% and has a b* value (BN), and wherein the resulting polyester solids mixture has a b* value (BM), wherein BM<0, BN<0 and BR>BN.

13. The process according to claim 12, wherein a coloring additive having a negative b* value is added to a process chain for producing the polyester prepolymer from a polyester manufacturing process prior to combining with the recycled polyester material, wherein the coloring additive is added to the polyester material from a polyester manufacturing process without prior dilution or as part of an additive mixture which further comprises a monomer of the polyester, and no coloring additive having a negative b* value is added to the recycled polyester material prior to combining with the polyester material from a polyester manufacturing process.

14. The process according to claim 12, wherein the polyester is polyethylene terephthalate and the monomer of the polyester is ethylene glycol.

15. The process according to claim 12, wherein BN is <−3.

16. The process according to claim 12, wherein the polyester solid mixture produced is treated in a reactor for a thermal treatment of bulk materials with a process gas in countercurrent or crosscurrent to a flow direction of the mixture.

17. The process according to claim 12, wherein the production and processing of a mixture of recycled polyester material and a polyester prepolymer from a polyester manufacturing process comprises the following steps:
Providing a recycled polyester material in the form of a melt and first purification of the melt by removing solid impurities using melt filtration;
Mixing of the recycled polyester material in the form of a melt with a polyester prepolymer in the form of a melt from a polyester manufacturing process and subsequent production of a solid mixture;
Treatment of this solid mixture in a reactor for thermal treatment of bulk materials with a process gas in counterflow or crossflow to a flow direction of the mixture;
wherein at least for a first period after the start of the process, prior to the production of the solid mixture, at least one additional step is carried out to purify the melt by removing solid impurities to obtain a purer recycled polyester material.

18. The process according to claim 17, wherein the additional step of purifying the melt of the recycled polyester material is carried out by means of melt filtration.

19. The process according to claim 18, wherein the additional step of purifying the melt of the recycled polyester material is carried out by a melt filter whose openings have an average size which is larger than an average size of the openings of the melt filter used in the first purification.

20. The process according to claim 19, wherein the additional step of purifying the melt of the recycled polyester material by means of melt filtration is carried out before the step of mixing the recycled polyester material in the form of a melt with the polyester prepolymer in the form of a melt from a polyester manufacturing process.

21. The process according to claim 20, wherein the additional step of purifying the melt of the recycled polyester material by means of melt filtration is carried out after the step of mixing the recycled polyester material in the form of a melt with the polyester prepolymer in the form of a melt from a polyester manufacturing process.

22. The process according to claim 17, wherein the additional step of purifying the melt of the recycled polyester material is realized by introducing the polyester prepolymer in the form of a melt from a polyester manufacturing process or the recycled polyester material in the form of a melt, in each case with entrainment of deposited impurities from at least one section of a melt line, into a second particle forming device and the production of the solid material with discharge of entrained deposited impurities in the second particle forming device.

23. The process according to claim 22, wherein a further step for purifying the melt of the recycled polyester material is carried out by means of melt filtration, wherein a melt filter is used for the further purification step, the openings of which have an average size which is larger than an average size of the openings of the melt filter used in the first purification step, and wherein the further step for purification by means of melt filtration is carried out after the step of mixing the recycled polyester material in the form of a melt with the polyester prepolymer in the form of a melt from a polyester manufacturing process.

24. A process for producing a formed article comprising forming a formed article from a polyester solid mixture prepared according to claim 12, wherein no coloring additive having a negative b* value is added during forming of the formed article and the formed article has a b* value (BF), wherein BF<0.
